(19) United States
(12) Patent Application Publication
(10) Pub. No.: US 2024/0169367 A1
(43) Pub. Date: May 23, 2024

(54) Systems and Methods for Employee Benefit Plan Compliance Optimization

(71) Applicant: NPPG Holdings, LLC, Shrewsbury, NJ (US)

(72) Inventors: Jared Stipelman, Manalapan, NJ (US); Debra Hettler, Atlantic Beach, FL (US)

(21) Appl. No.: 18/512,823

(22) Filed: Nov. 17, 2023

Related U.S. Application Data
(60) Provisional application No. 63/384,163, filed on Nov. 17, 2022.

(51) Int. Cl. G06Q 30/018; G06Q 10/1057

(52) U.S. Cl. CPC G06Q 30/018; G06Q 10/1057

(57) ABSTRACT

The disclosed technology includes employee benefit plan compliance optimization systems and methods. In one example, a method for optimizing employee benefit plan regulation compliance includes receiving first participant data from a first third-party data source and second participant data from a second third-party data source; retrieving mapping data associated with the second third-party data source, wherein the mapping data maps a plurality of first parameters of the first participant data to a plurality of second parameters of the second participant data; determining second participant data entries of the second participant data that match with first participant data entries of the first participant data based on the mapping data; and comparing simultaneously the first participant data entries to the matching second participant data entries based on the mapping data to determine one or more discrepancies in participant data.

### CROSS REFERENCE TO RELATED APPLICATIONS

The present application claims the benefit of priority to U.S. Provisional Patent Application No. 63/384,163, entitled “Systems and Methods for Pension Compliance Optimization,” filed Nov. 17, 2022, the entirety of which is hereby incorporated by reference herein for all purposes.

### TECHNICAL FIELD

The technology described herein relates generally to optimizing employee benefit plan compliance.

### BACKGROUND

Employee benefits include health insurance, life and disability insurance, retirement plan benefits, paid-time-off benefits, educational assistance programs, and other benefits. Various employee benefit plans are governed by various rules and regulations, primarily by federal statutory law, which are constantly evolving. For example, the Employee Retirement Income Security Act of 1974 (ERISA) is a federal law that sets minimum standards for most voluntarily established retirement and health plans in private industry to provide protection for individuals in these plans. ERISA requires plans to provide participants with plan information including important information about plan features and funding; sets minimum standards for participation, vesting, benefit accrual and funding; provides fiduciary responsibilities for those who manage and control plan assets; requires plans to establish a grievance and appeals process for participants to get benefits from their plans; and gives participants the right to sue for benefits and breaches of fiduciary duty.

To encourage employers to provide pension plans that comply with ERISA, Congress has authorized tax breaks to employers who are compliant. Title 26 (the Internal Revenue Code) establishes numerous qualifications and requirements in order for an employer to receive special tax treatment. For example, pension plans must be vested and must meet minimum coverage requirements.

Given the vast amount of rules and regulations and their evolving nature, it can be difficult for employers to monitor employee benefit plan compliance efficiently and effectively. Current systems and practices for monitoring compliance are time consuming, slow, and inefficient.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes pension compliance optimization systems and methods. Embodiments of the present disclosure may include a pension regulation compliance optimization system. The pension regulation compliance optimization system may include one or more client devices, a processor in communication with the one or more client devices, two or more third-party data sources in communication with the processor, and a database in communication with the processor. A first third-party data source of the two or more third-party data sources may store a first set of participant data and a second third-party data source of the two or more third-party data sources may store a second set of participant data. The processor may be configured to receive a plurality of participant data sets from the two or more third-party data sources, wherein the plurality of participant data sets include the first set of participant data and the second set of participant data; determine, based on a common identifier associated with the first set of participant data and the second set of participant data, that the first set of participant data and the second set of participant data are related; transform the first set of participant data and the second set of participant data into a uniform format; compare the first set of participant data and the second set of participant data based on the uniform format; determine one or more discrepancies in participant data between the first set of participant data and the second set of participant data based on the comparison; and transmit an alert to the one or more client devices based on the one or more discrepancies.

Additionally or separately, the processor may be configured to receive user input from the one or more client devices correcting the one or more discrepancies in the participant data; create validated participant data based on the first set of participant data, the second set of participant data, and the corrected participant data; and store the validated participant data in the database. Additionally or separately, the processor may be configured to execute simultaneously a series of pension compliance tests based on the validated participant data. Execution of a pension compliance test of the series of pension compliance tests may include executing simultaneously a plurality of trial runs of the pension compliance test based on the validated participant data and a plurality of interpretations of one or more test parameters of the pension compliance test; and determining one or more interpretations of the plurality of interpretations that result in a passing test score. Additionally or separately, the processor may be configured to determine risks associated with the one or more interpretations; determine whether a high risk threshold has been reached for the series of pension compliance tests; apply available low risk interpretations of the one or more interpretations to the pension compliance test when the high risk threshold has been reached; and apply available high risk interpretations of the one or more interpretations to the pension compliance test when the high risk threshold has not been reached and no low risk interpretations are available.

Additionally or separately, the processor may be configured to monitor third-party databases for changes in pension regulations based on pension plan related key words and rule numbers; determine a new or modified regulation based on new language or a new rule number; generate a copy of the new or modified regulation; transmit the copy of the new or modified regulation to a client device; and receive a new or modified compliance test based on the new or modified regulation.

Other examples or embodiments of the present disclosure may include a method, executable by a programmed processor, for optimizing pension regulation compliance. The method may include receiving a plurality of participant data from two or more third-party data sources; associating participant data from the plurality of participant data with a participant or plan; aggregating and validating the participant data associated with the participant or plan; executing a plurality of trial runs of a pension compliance test based on the validated participant data, wherein the plurality of trial runs vary one or more interpretations of one or more compliance test parameters; and determining one or more passing interpretations from the one or more interpretations that result in a passing test score.

Additional examples or embodiments of the present disclosure may include a method for optimizing employee benefit plan regulation compliance. The method may be executable by a programmed processor and may include receiving first participant data from a first third-party data source and second participant data from a second third-party data source. The first participant data may include a plurality of first participant data entries and a plurality of first parameters, and the second participant data may include a plurality of second participant data entries and a plurality of second parameters. The plurality of first participant data entries may include first parameter inputs that correspond to the plurality of first parameters, and the plurality of second participant data entries may include second parameter inputs that correspond to the plurality of second parameters. The method may further include retrieving, from a database associated with the processor, mapping data associated with the second third-party data source, wherein the mapping data maps the plurality of first parameters to the plurality of second parameters; determining second participant data entries that match with first participant data entries based on the mapping data; and comparing simultaneously the first participant data entries to matching second participant data entries to determine one or more discrepancies in participant data, wherein comparing the first participant data entries to matching second participant data entries comprises comparing first parameter inputs to second parameter inputs based on the mapping data.

Further examples or embodiments of the present disclosure may include a method of generating a pre-validated employee benefit plan data reporting form. The method may include receiving, by a processor, first census data in a first data format and second census data in a second data format. The first census data may include first employee benefit plan participant data entries and first census parameters, and the second census data may include second employee benefit plan participant entries and second census parameters. The first employee benefit plan participant data entries may include first census parameter inputs that correspond with the first census parameters and the second employee benefit plan participant entries may include second census parameter inputs that correspond with the second census parameters. The method may further include receiving, by the processor, mapping data that identifies the second census parameters based on corresponding first census parameters; determining, by the processor, first employee benefit plan participant data entries that match second employee benefit plan participant data entries based on the mapping data; comparing, by the processor, first census parameter inputs to corresponding second census parameter inputs of matching first employee benefit plan participant data entries and second employee benefit plan participant data entries, wherein the corresponding second census parameter inputs correspond to the first census parameter inputs based on the mapping data; determining, by the processor, mismatched census parameter inputs based on first census parameter inputs that differ in value from the corresponding second census parameter inputs and matching census parameter inputs based on first census parameter inputs that have a same value as the corresponding second census parameter inputs; outputting, by the processor, discrepancy data identifying the mismatched census parameter inputs; receiving, by the processor, validated census data comprising the matching census parameter inputs and corrected census data related to the mismatched census parameter inputs; and populating, by the processor, fillable fields in an employee benefit plan reporting form with the validated census data.

Other examples or embodiments of the present disclosure may include an employee benefit plan regulation compliance optimization system. The system may include one or more client devices; a processor in communication with the one or more client devices; two or more third-party data sources in communication with the processor, wherein a first third-party data source of the two or more third-party data sources stores a first set of participant data and a second third-party data source of the two or more third-party data sources stores a second set of participant data; and a database in communication with the processor. The processor may be configured to receive, from the two or more third-party data sources, the first set of participant data and the second set of participant data, wherein the first set of participant data is in a system data format and the second set of participant data is in a non-system data format; receive, from the database, mapping data that translates the non-system data format to the system data format; compare the first set of participant data and the second set of participant data based on the mapping data; determine one or more discrepancies between the first set of participant data and the second set of participant data based on the comparison; and generate a report based on the one or more discrepancies.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a block diagram illustrating an example of a disclosed employee benefit plan compliance optimization system.

FIG. 2 is a block diagram of an exemplary data storage device storing various data and instructions that can be used with the system of FIG. 1 for implementing disclosed system functionality.

FIG. 3 is a flow chart illustrating a method of validating participant data.

FIG. 4 is a flow chart illustrating a method of monitoring changes in employee benefit plan regulations.

FIG. 5 is a flow chart illustrating a method of optimizing employee benefit plan compliance while minimizing risk.

FIG. 6A is a flow chart illustrating a method of validating participant data for improved accuracy of employee benefit plan compliance.

FIG. 6B is a flow chart illustrating a method of generating a pre-validated data reporting form for employee benefit plan compliance.

FIG. 7 shows exemplary data formats for participant data received from two different third-party data sources.

FIG. 8 shows an image of an exemplary graphical user interface for generating mapping data stored by the system of FIG. 1.

FIG. 9A shows an image of a graphical user interface displaying a first portion of an exemplary output of discrepancy or error data.

FIG. 9B shows an image of a graphical user interface displaying a second portion of the output of FIG. 9A.

FIG. 10 shows an image of an exemplary exported data table, including discrepancy or error data.

FIG. 11 is a simplified block diagram of a computing device that can be used by one or more components of the system of FIG. 1.

### DETAILED DESCRIPTION

Disclosed herein are employee benefit plan compliance optimization systems and methods. In several embodiments, the disclosed employee benefit plan compliance optimization systems and methods include simultaneous validation of data related to numerous employee benefit plan participants. Plan participant data may be received from multiple third-party data sources. The system may account for differences in data formats and data labeling received from different third-party data sources to compare participant data inputs or values for the same participant data parameters. Plan participant data that is relevant for employee benefit plan compliance testing may be compared between the different third-party data sources to determine errors or discrepancies in the plan participant data. The system may receive corrections of the determined errors or discrepancies and may generate validated participant data for use in employee benefit plan compliance testing.

Employee benefit plans include health care plans, life and disability insurance plans, employee retirement benefit plans, and the like. Employee benefit plans may include different types of plans for different benefits. As an example, employee retirement benefit plans include pension plans, 401(K)s, 403(b)s, and others.

Plan participant data (also referred to as “participant data”) may include data related to the employee benefit plan participants (e.g., employees). For example, plan participant data may include census data (e.g., personal identification information such as name, date of birth/age, social security number, marital status, citizenship, etc.), length of time employed, date of hire or rehire, date of termination, salary or other pay, breaks in service (e.g., quit, fired and returned, etc.), length of any breaks in service, compensation information (e.g., monthly paycheck, bonuses, overtime), payroll data, desired retirement plan contribution amounts, actual retirement plan contribution amounts, sources of contributions, pre-tax contributions, post-tax contributions, loan payments, investments, and the like. The above types of plan participant data may be referred to herein as “participant data parameters” or “parameters.”

Participant data may come from multiple data sources. For example, participant data may be received from a recordkeeper (e.g., a company that retains records on financial assets and other personal information), plan sponsor (e.g., the employer or human resources department), insurance provider, financial institution, trustee, fiduciary, payroll vendor, third-party administrator (TPA), and the like. Such data may be in different formats or categorized or labeled in different ways based on different data systems and/or nomenclature systems adopted by different data sources. As such, in several embodiments, disclosed systems and methods include mapping third-party data formats or structures to a uniform data format or structure stored by the system. In some embodiments, disclosed systems and methods include translating the participant data and transforming it into a uniform data format for more efficient data interpretation and analysis. The mapping or translated data may be stored by the system.

The data from the third-party data sources may include some errors, as the data can be voluminous. As such, by receiving data from multiple third-party data sources, errors in data can be flagged and corrected, increasing accuracy of the data analyzed by the system. By validating participant data prior to utilizing the data for employee benefit compliance testing, disclosed systems and methods optimize employee benefit plan compliance.

Pension plans are one example of an employee benefit plan that is subject to compliance testing. Pension plans are a specific retirement benefit provided to employees. A pension plan requires the employer to contribute to a pool of funds that is set aside for an employee's retirement. Employers that provide pension plans must comply with various regulations governing pension plans and with certain IRS requirements to receive tax benefits for providing compliant pension plans. In order to ensure that pension plans do not violate certain standards imposed by the Department of Labor (DOL) and Internal Revenue Service (IRS), such plans are subjected to annual compliance tests.

As an example, the IRS requires that retirement plans perform annual non-discrimination tests to ensure benefits from a company's 401(k) plan are widely shared and that the plan does not disproportionately favor employees classified as “highly compensated employees” (HCE) from those classified as “non-highly compensated employees” (NHCE). An example of a non-discrimination test is the Actual Deferral Percentage (ADP) Test, which compares the average deferral rates (i.e., total annual deferral divided by total compensation) of HCEs to NHCEs. To pass this test, the average deferral rate for HCEs may only exceed the NHCEs by a certain limit. Another non-discrimination test is the Actual Contribution Percentage (ACP) Test, which compares the average contribution percentage (i.e., total employer match (plus any post-tax contributions made by employee) divided by the employee's total compensation) of HCEs to NHCEs. To pass this test, the HCE group contribution percentage may only exceed the NHCE group percentage by a certain limit.

Another exemplary compliance test assesses whether contributions to the pension plan are made in a timely manner. Whether the contribution is timely may depend on different factors (or parameters), such as, for example, the frequency of payroll distributions. Such compliance tests often involve comparing employee or plan participant data to a standard or to other participant's data.

Laws and regulations governing employee benefit plans, including pension plans, are constantly evolving. Many of these laws and regulations are overlapping and appear to be conflicting or contradictory, such that different interpretations or assumptions are allowed for compliance. Some interpretations or assumptions are riskier than others. For example, an interpretation that favors the employer or plan over the employee may be considered an aggressive interpretation that is subject to high risk, i.e., high risk of rejection during an audit. Often, the various compliance tests are weighted for overall general compliance, and some high risk interpretations are allowed if there are an adequate number of low risk interpretations.

With the numerous and constantly changing regulations and associated compliance tests, the numerous different interpretations of compliance test parameters, and the need to test compliance with all plan participants (e.g., all employees), it can be difficult for employers to assess employee benefit plan compliance adequately and accurately as there are a myriad of possible combinations of tests, interpretations, and risks. Further, the information related to employee benefit plans and plan participants that is obtained from recordkeepers, plan sponsors, or other third party administrators for compliance is often inaccurate, further complicating compliance with employee benefit plan regulations as it can be difficult to determine errors in the data and make corrections. Current practices to reconcile errors in such data are time consuming, inefficient, and subject to human error. In several embodiments, disclosed employee benefit plan compliance optimization systems and methods aim to facilitate employee benefit plan compliance by creating a unique employee benefit plan compliance optimization data architecture.

In several embodiments, the disclosed employee benefit plan compliance optimization systems and methods include dynamic evaluation and application of employee benefit plan compliance tests to optimize employee benefit plan compliance while minimizing risk. Such systems and methods may include determining applicable interpretations or assumptions for compliance test parameters or variables based on participant data and risk tolerance, and applying those interpretations or assumptions to the applicable employee benefit plan compliance tests to achieve a passing employee benefit plan compliance test score.

In several embodiments, employee benefit plan compliance optimization systems and methods include validating participant data, determining relevant and current compliance tests, determining applicable interpretations to satisfy a passing compliance test score based on the valid participant data, determining the associated risks of the applicable interpretations, and applying an applicable interpretation based on the associated risk to the compliance test to achieve a passing compliance test score that mitigates risk.

In several embodiments, disclosed employee benefit plan compliance optimization systems and methods include dynamic monitoring of third-party websites and/or databases for relevant changes in employee benefit plan regulations. For example, third-party websites and/or databases may be monitored based on keywords related to employee benefit plans and the regulations that govern them (e.g., pension, contribution, distribution, ERISA, etc.), relevant statutes or rules (e.g., Title 29 of the Code of Federal Regulations, etc.), and/or departments (e.g., the DOL or IRS). As used herein, “regulations” refers to any laws, legislation, rules, statutes, or other regulations or guidelines that govern or are related to employee benefit plans. An employee benefit plan may also be governed by a plan document or contract that outlines the bounds of the plan. As used herein, “regulations” may also include the terms of a participant's plan. By monitoring third-party websites and/or databases, disclosed employee benefit plan compliance optimization systems and methods may periodically or continuously update the relevant compliance tests to ensure compliance with current employee benefit plan regulations.

Disclosed employee benefit plan compliance optimization systems and methods may flag changes in employee benefit plan regulations. The flagged changes may be transmitted to a system operator or a plan administrator. Disclosed employee benefit plan compliance optimization systems and methods may receive user input related to new or modified compliance tests based on the flagged changes. A modified compliance test may adjust the parameters and/or interpretations applied to an existing compliance test.

In several embodiments, disclosed employee benefit plan compliance systems and methods include interpreting multiple employee benefit plan regulations simultaneously to dynamically determine the viability of different employee benefit plan compliance tests based on the received participant data.

In several embodiments, disclosed employee benefit plan compliance optimization systems and methods include comparing various combinations of compliance tests and interpretations to achieve overall compliance based on the received participant data. Disclosed employee benefit plan compliance optimization systems and methods may simultaneously execute multiple trial runs of a compliance test, applying different interpretations to the test parameters in different combinations, to determine which interpretations or combinations of interpretations as applied to the compliance test result in a passing compliance test score. In some embodiments, a plurality of interpretations and/or combinations of interpretations may result in a plurality of passing compliance test scores.

In several embodiments, the selection of interpretations or combinations of interpretations may be based on a risk assessment. For example, certain interpretations may be high risk, while other interpretations may be low risk. Interpretations may be selected for a particular employee benefit plan compliance test based on their associated risk. The overall risk associated with the compliance test score may be dependent on the risk associated with the applied interpretations. For example, a high risk employee benefit plan compliance test may incorporate one or more high risk interpretations or assumptions. A threshold number of high risk interpretations and/or high risk compliance scores may be permissible for overall compliance with employee benefit plan regulations. Because the number of high risk interpretations is limited, low risk interpretations that result in a passing compliance score may be selected if available. If a high risk interpretation is needed to pass a compliance test, the high risk interpretation will be selected if the threshold number of allowable high risk interpretations and/or high risk employee benefit plan compliance scores have not been met. In this manner, the system is able to optimize compliance while mitigating risk. In embodiments where a plurality of interpretations and/or combinations of interpretations result in a plurality of passing compliance test scores, the interpretations and/or passing test scores with the least risk may be selected by the system to optimize compliance while mitigating risk.

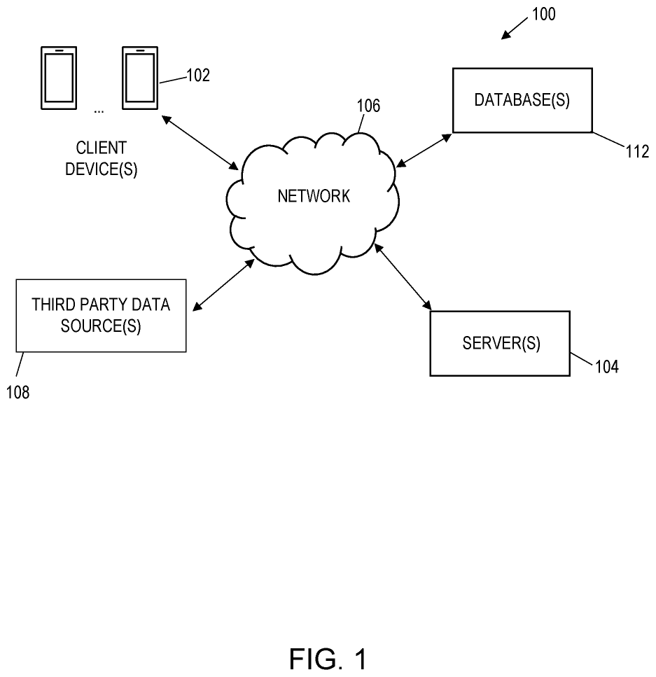

Turning now to the figures, systems and methods of the present disclosure will be discussed in more detail. FIG. 1 is a block diagram illustrating an example of an employee benefit plan compliance optimization system 100. The system 100 includes one or more client devices 102. In some embodiments, the one or more client devices 102 are in communication with one or more servers 104, via network 106, which in turn may be in communication with one or more third-party data sources 108 and one or more databases 112, via network 106. Each of the various components of the employee benefit plan compliance optimization system 100 may be in communication directly or indirectly with one another, such as through the network 106. In this manner, each of the components can transmit and receive data from other components in the system 100. In many instances, the one or more servers 104 may act as a go between for some of the components in the system 100.

The one or more client devices 102 may include various types of computing devices, e.g., mobile devices, smart displays, tablet computers, desktop computers, laptop computers, or the like. The one or more client devices 102 provide output to and receive input from a user. Examples of users of the employee benefit plan compliance optimization system 100 include plan participants (e.g., employees or employers), plan administrators or providers, bookkeepers or recordkeepers, and system administrators or administrative users and analyst users (e.g., coders or software engineers) supporting the employee benefit plan compliance optimization system 100. The one or more client devices 102 may receive one or more alerts, notifications, or feedback from the one or more servers 104 indicative of errors in participant data, new employee benefit plan regulations, changes to employee benefit plan regulations, and compliance and/or non-compliance with employee benefit plan regulations. The type and number of client devices 102 may vary as desired.

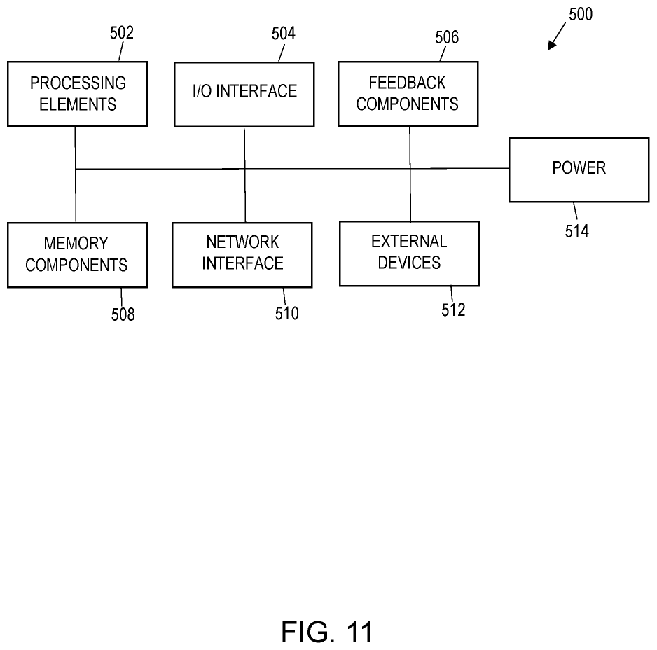

The one or more servers, central processing unit(s), or remote processing element(s) 104 are one or more computing devices that process and execute information. The one or more servers 104 may include their own processing elements, memory components, and the like, and/or may be in communication with one or more external components (e.g., separate memory storage)(an example of computing elements that may be included in the one or more servers 104 is disclosed below with respect to FIG. 11). The one or more servers 104 may include one or more server computers that are interconnected together via the network 106 or separate communication protocol. The one or more servers 104 may host and execute a number of the processes executed by the system 100.

The one or more third-party data sources 108 may include a third-party database or other form of storage, such as, for example, a document, spreadsheet, or form. The one or more third-party data sources 108 may store and provide information related to participant data, regulations data, compliance test data, test parameter interpretation data, risk data, and the like. The third party providing such data may include a record keeper, plan sponsor (e.g., the employer or human resources department), and the like.

Regulations data may include statute or rule numbers, statutory language, cases, or other law or regulations related to employee benefit plans. Regulations data may include changes to regulations or new regulations. Compliance test data may include information related to the various compliance tests required of plan providers to comply with laws and regulations governing employee benefit plans. Such data may include test parameters and data related to compliant results (e.g., passing compliance test scores) and non-compliant results (e.g., failing compliance test scores). The third party providing the regulations data and compliance test data may include a government body (e.g., the IRS or DOL) or educational website (e.g., law review, the Legal Information Institute, etc.) or other legal source (e.g., the Federal Register). It is contemplated that the compliance test data may be input by a system user or determined by the system 100 (e.g., based on the regulations data and/or user feedback over time).

Test parameter interpretation data may include one or more interpretations of test parameters. As an example, a test parameter for a non-discrimination compliance test may be an amount of pensionable compensation. The interpretation of what constitutes pensionable compensation may vary. As an example, some interpretations may consider fringe benefits as a pensionable compensation, while others may not. The term “fringe benefits” may also have various interpretations. For example, some interpretations may consider a gym membership a fringe benefit, while others may not. The third party or data source providing the test parameter interpretation data may include a government body, an employee benefit plan or legal expert, a treatise, or other verified third party that interprets such regulations.

Risk data may include risk factors or values associated with the different interpretations of test parameters and high risk and low risk thresholds associated with compliance test scores. For example, the interpretations may be associated with certain risks, depending on how aggressive the interpretation is. For example, an aggressive interpretation that favors the plan or employer over the employee may be associated with a high risk factor or value while a conservative interpretation that favors the employee may be associated with a low risk factor or value. The third party providing this risk data may be a government body (e.g., IRS opinion letter) or a risk assessment expert. The risk data may also be input by a system administrator. The risk data may be stored by one or more associated databases (e.g., the one or more databases 112 described below) as a correlation table or other data structure correlating or associating interpretations with their associated risk values.

The one or more databases 112 are configured to store information related to the systems and methods described herein. The one or more databases 112 may store data collected or received by the system 100, such as, for example, participant data, mapping data, regulations data, compliance test data, test parameter interpretation data, risk data, historical third-party data, and the like. The one or more databases 112 may store data collected over time. For example, the one or more databases 112 may store new regulations or changes in regulations over time. The one or more databases 112 may store user input. For example, user input may associate a particular test or parameter with certain regulatory language. As another example, user input may associate a particular risk factor or value with a test parameter interpretation. It is contemplated that the one or more databases 112 may include a non-linear database.

The one or more databases 112 may store data determined by the system 100. For example, the one or more databases 112 may store compliance data, which includes data related to employee benefit plan compliance for plan participants. Such compliance data may include whether a particular plan participant's plan is compliant or not and/or different assessments of the level of risk associated with the determined plan compliance. As an example, such data may be used during audits to assess employee benefit plan compliance.

The network 106 may be substantially any type or combination of types of communication systems for transmitting data either through wired or wireless mechanisms (e.g., WiFi, Ethernet, Bluetooth, cellular data, or the like). In some embodiments, certain components of the compliance system 100 may communicate via a first mode (e.g., Cellular) and others may communicate via a second mode (e.g., WiFi). Additionally, certain components may have multiple transmission mechanisms and be configured to communicate data in two or more manners.

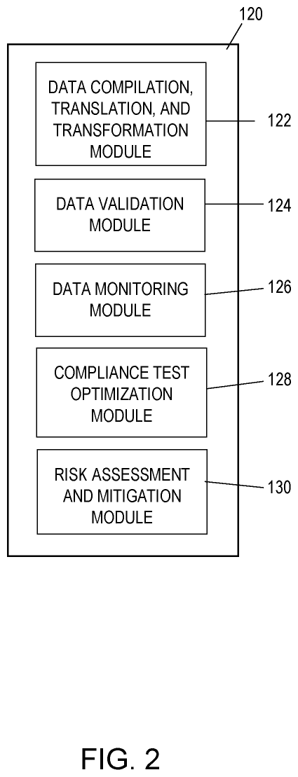

FIG. 2 is a block diagram of an exemplary data storage device storing various data and instructions that can be used with the system of FIG. 1 for implementing disclosed system 100 functionality. In an exemplary implementation, the data storage device 120 may store a data compilation, translation, and transformation module 122 (referred to as the “data CTT module” herein), a data validation module 124, a data monitoring module 126, a compliance test optimization module 128, and a risk assessment and mitigation module 130, and any other programs, functions, filters, and algorithms necessary to implement the methods described herein. The data storage device 120 may also store an operating system, one or more application programs, and data files.

The data CTT module 122 may compile data related to employee benefit plan compliance, such as participant data, translate or map the data as corresponding to data in a uniform format, and transform the data into the uniform data format that can be used by the system. For example, such data may come from various sources that use different language, format, coding, and naming systems for the same or similar data. The different sources may provide the same type of data. For example, census data may come from a recordkeeper (e.g., insurance company) and plan sponsor. However, the same type of data may come in different formats. As an example, one third-party data source may provide a data point as a single line item, while another third-party data source may provide the data point as multiple line items. In this example, the data CTT module 122 may determine which line items to combine to match the data provided by the single line item. In several embodiments, the data CTT module 122 may receive source code or a data format or structure (e.g., a data table) from the third-party data sources and store the source code or data format or structure over time as historical third-party data.

The data CTT module 122 may mark the third-party source code or data format or structure with identifiers or tags that represent a particular data set or parameter. In several embodiments, the data CTT module 122 may learn over time to identify or tag certain data sets or parameters in third-party source code or data formats or structures. As an example, a first third-party may provide data in source code K. The data CTT module 122 may recognize that data coded as A in source code K is a pre-tax contribution. The data CTT module 122 may receive source code L from a second third-party and may recognize that data coded as B in source code L is a pre-tax contribution. In this example, the data CTT module 122 may define data coded differently (e.g., as A or B) from different data sources as the same data set. In this example, the data CTT module 122 may tag the data coded A from source code K and data coded B from source code L with the tag PT (e.g., for pre-tax contribution) (or transform the data into the same uniform format of PT). The data CTT module 122 may store source code, data formats or structures, or other third-party data with the associated tags or with the uniform data format as historical third-party data. The tags (or uniform data format) may allow the data validation module 124, discussed below, to quickly translate or recognize like or similar data from different third-party data sources for comparison of the same/similar data.

In several embodiments, the data CTT module 122 may receive user input identifying or tagging third-party data source codes with uniform labels, tags, identifiers, data formats, or predefined translations. The uniform labels, identifiers, tags, data formats, or predefined translations may be stored in association with the respective third-party data source code as historical third-party data by the data CTT module 122. The data CTT module 122 may associate participant data received from a third-party data source with stored historical third-party data to determine applicable uniform labels or data formats. The data CTT module 122 may transform the participant data with the uniform labels or data formats associated with the associated stored historical third-party data.

In some embodiments, the data CTT module 122 may be a mapping module. The mapping module may map third-party data formats to a uniform system data format. For example, the mapping module may store associations between third-party data formats and the uniform system data format. As one example, the system may store location information for parameters within the third-party data structure that correspond to parameters in the uniform system data format. As an example, the system may store data indicating the location for the parameter “SSN” in column 3 in a third-party data structure corresponds to the parameter “social security number” in column 2 in the uniform system data format. In these embodiments, transformation of data may be omitted.

When the data CTT module 122 receives a new source code or a new data format from a new third-party data source, it may translate, map, and/or transform the source code or data format based on stored predefined translations or mapping. In some embodiments, when the data CTT module 122 recognizes a source code or data format received is new (e.g., by comparing it to stored source code or data formats), it may transmit an alert to a client device. Source code or data format translations or mapping or uniform tags for the new source code or data format may be received from a client device receiving and transmitting user input. The source code or data format translations or mapping or uniform tags associated with the new source code or data format from the new third-party data source may be stored as historical third-party data.

The data CTT module 122 may compile, translate or map, and/or transform numerous (e.g., tens of thousands) data sets or line items simultaneously. For example, the data CTT module 122 may receive data related to multiple employee benefit plans and plan participants. As discussed above, the data for an employee benefit plan or plan participant may be received from multiple sources (e.g., a recordkeeper and a plan sponsor). The data CTT module 122 may determine which data sets of the plurality of data sets received are associated with the same plan or plan participant. For example, different third-party data sources may have unique identifiers or labels for the plan or plan participant. The data CTT module 122 may transform or map the identifier or label associated with the plan or plan participant from the different third-party data sources to a uniform identifier or label or otherwise tag the data with the same marker. The data may be associated and stored as part of the same plan or plan participant data.

It is also contemplated that the employee benefit plan-related data may be from a form or other document. Different third-party data sources may use different terms that have the same meaning. For example, an elective deferral may be called a 403a deferral, a deferral, an employee deferral, or a pretax deferral. The data CTT module 122 may store different terminology for employee benefit plan-related or financial-related terms and may retrieve such data to translate and transform the third-party data received into a uniform language. For example, a form from a recordkeeper may have a line for “403a deferral,” while a form from a plan participant may have a line for “employee deferral.” The data CTT module 122 may label both lines an “elective deferral” based on stored terminology data, allowing a comparison of the same data. It is contemplated that “elective deferral” may be associated with a tag and the data CTT module 122 may tag the data with the associated tag. For example, the tag ED may be associated with the “403a deferral” data and with the “employee deferral” data, which may be interpreted by the system as “elective deferral” data.

The data validation module 124 may compare similar data (e.g., participant data) from different sources based on the translation, mapping, and/or transformation of the data to a uniform data format and determine discrepancies or inconsistencies in the data. For example, data from a recordkeeper may be compared with data from a plan sponsor. In the above example, the data validation module 124 may compare the data coded as A in source code K with the data coded as B in source code L to determine whether there are discrepancies in the pre-tax contribution amount provided by the two different third-party data sources. In embodiments where third-party source code is tagged, as discussed above, the tags may be compared to determine similar data sets. For example, if tags match, then the data validation module 124 may determine that the associated data sets are similar or match.

As an example, the data validation module 124 may compare deduction data in source code from payroll to deduction data in source code from a recordkeeper to ensure that any deductions selected by an employee through the recordkeeper are being deducted by payroll.

The data validation module 124 may flag discrepancies or conflicts in the data from different sources or otherwise alert a user of the same. In some embodiments, the data validation module 124 may alert both third parties that provided the data of the discrepancy or conflict for them to review and correct the error or conflict or confirm which data set is correct. In some embodiments, the data validation module 124 may determine the correct data set and alert the third party that provided the incorrect data set of the error in the data.

The data validation module 124 may receive user input on correct data, resolving the discrepancy or conflict in data. In some embodiments, the data validation module 124 may determine data is correct without alerting a third party or receiving third-party input. For example, if one party provided data that the other party omitted, the data validation module 124 may assume the data provided is correct and that the missing data is incorrect. In some embodiments, the data validation module 124 may determine correct data based on data provided and stored algorithms or equations. For example, the data validation module 124 may calculate a contribution rate based on other data provided by the third-party data sources. For example, the data validation module 124 may determine a baseline deferral percentage based on a first payroll distribution and in absence of future inputs may use such first payroll distribution to calculate future deferral percentages based on the baseline value.

As such, the system 100 may validate data received related to employee benefit plans (e.g., participant data) to ensure employee benefit plan compliance assessments and risk assessments that are based on the data are accurate. By increasing accuracy related to employee benefit plan compliance assessments and risk assessments, penalties resulting from non-compliance with employee benefit plan regulations can be avoided.

The data validation module 124 may compare numerous (e.g., tens of thousands) data sets or line items simultaneously. As discussed above, the system 100 may receive data related to multiple employee benefit plans and plan participants. The data validation module 124 may determine which data sets are associated with the same plan or plan participant based on stored data and compare data associated with the same plan or plan participant. The data validation module 124 may compare data associated with different plans or plan participants simultaneously and may flag errors in the data.

The data monitoring module 126 may monitor third-party websites and/or databases for relevant changes in employee benefit plan regulations. For example, third-party websites and/or databases may be monitored based on keywords related to employee benefit plans and the regulations that govern them (e.g., pension, contribution, distribution, ERISA, etc.), relevant statutes (e.g., Title 29 of the Code of Federal Regulations), and/or departments (e.g., the DOL or IRS). By monitoring third-party websites and/or databases, the data monitoring module 126 may alert users of applicable and relevant compliance tests and periodically or continuously update the same to ensure compliance with current rules and regulations.

The data monitoring module 126 may flag changes in employee benefit plan regulations. The flagged changes may be transmitted to a system operator or a plan administrator. The data monitoring module 126 may receive user input related to modified or new compliance tests based on the flagged changes.

It is contemplated that the data monitoring module 126 may associate changes in employee benefit plan regulations with certain compliance tests, compliance test parameters, and/or parameter interpretations. For example, the one or more databases 112 may store certain regulatory language and/or statute provisions or numbers in association with different compliance tests, test parameters, and/or parameter interpretations that can be retrieved by the data monitoring module 126. The data monitoring module 126 may associate the revised regulation with one or more compliance tests, test parameters, and/or parameter interpretations based on this stored data. As another example, the data monitoring module 126 may detect certain language in the regulation that corresponds to stored test parameters and/or interpretations. For example, the data monitoring module 126 may detect the term “fringe benefits” in the revised regulation and correlate the revised regulation with compliance tests that incorporate the term “fringe benefits” as a test parameter and/or interpretation.

The data monitoring module 126 may transmit an alert to a client device 102 related to the one or more compliance tests, test parameters, and/or parameter interpretations that may need to be adjusted based on the revised or flagged regulation. The data monitoring module 126 may transmit the alert as the flagged regulation is detected or it may store the data in association with the respective compliance test and transmit the alert when the compliance test is executed by a user. In the above example, as a compliance test is executed that takes into account fringe benefits, an alert may be transmitted warning that there is an update to a regulation that involves fringe benefits.

As an example, if a new rule states that fringe benefits are not part of pensionable income, the data monitoring module 126 may determine, based on stored correlation data, which compliance test(s) factor in “pensionable income” as a test parameter and/or “fringe benefits” as a test parameter interpretation. For example, the data monitoring module 126 may determine a non-discrimination test uses fringe benefits as an interpretation of pensionable income. In this example, the data monitoring module 126 may transmit an alert to a client device 102 (e.g., a system administrator) indicating that the non-discrimination test may need to be modified based on the new rule.

The compliance test optimization module 128 may perform compliance testing based on the validated data determined and stored by the data validation module 124 and compliance tests stored by the system related to employee benefit plan regulation compliance, including updated/modified or new compliance tests received and stored by the data monitoring module 126. The compliance test optimization module 128 may execute numerous trial runs of a compliance test simultaneously with different combinations of interpretations of test parameters to determine a combination that results in a passing compliance score. As an example, the compliance test optimization module 128 may execute multiple trial runs of a non-discrimination test, adjusting the test parameters based on different interpretations. For example, a 414(s) compensation test requires evaluation of various different types and forms of included and excluded compensation. Whether particular compensation inputs constitute subcategories of compensation such as “fringe benefits,” or “bonuses,” or “tips,” can be subject to reasonable interpretation. Whether a particular benefit constitutes a bonus can affect the 414(s) percentage, and be dispositive in determining success or failure of the test. Accordingly, the values or amounts of the test parameters (e.g., “bonuses”) may vary based on the interpretation applied (e.g., the benefit that constitutes a bonus).

A test parameter may have a plurality of test parameter factors that affect the test parameter value. It is contemplated that those test parameter factors in turn may have multiple interpretations, such that a test parameter may have a voluminous number of interpretations based on the different interpretations and/or combinations of interpretations of its test parameter factors. As one example, a test parameter for a non-discrimination test may be a required minimum distribution (e.g., the amount a participant is required to take out of his/her retirement account each year after a certain age). The required minimum distribution may have multiple factors that affect its value. As an example, age and life expectancy are factors affecting the required minimum distribution. Life expectancy may be calculated different ways, based on different interpretations. For example, life expectancy may be calculated based on one or more of age, gender, athletic habits, smoking habits, alcohol habits, income, and the like. As the life expectancy changes based on how it is calculated, so does the required minimum distribution. As such, there are numerous interpretations of the required minimum distribution.

By applying different interpretations to the test parameters, some interpretations may result in a passing compliance score. As an example, an interpretation of “total employer match” that includes employee's post-tax contributions may not pass the test while an interpretation that excludes employee's post-tax contributions may pass the test. The compliance test optimization module 128 may run through numerous permutations of an employee benefit plan compliance test with different interpretations and combinations of interpretations to determine one or more tests that have a passing compliance score.

In several embodiments, multiple employee benefit plan compliance tests may be available for a single test analysis (e.g., to comply with a single regulation). For example, a particular non-discrimination test may have multiple tests available that assess whether a plan or participant is compliant with the non-discrimination test (and associated regulation). As discussed, each of the multiple tests may have different test parameters with different interpretations and combinations of interpretations. In these embodiments, the system runs multiple trial runs for the multiple tests based on the associated and varying interpretations and combinations of interpretations. One or more combinations of tests and interpretations may pass the compliance test. In this manner, the system simultaneously analyzes numerous combinations of tests and interpretations to optimize compliance.

The risk assessment and mitigation module 130 may assess risks (e.g., risk of rejection during an audit) associated with different test parameter interpretations or combinations of interpretations and overall compliance test risks associated with a combination or series of compliance tests applying different interpretations and combinations of interpretations. Risks may be quantified as a percentage or a value on a risk scale. Some test parameter interpretations may be higher risk than others. For example, an interpretation that favors the employer or plan over the employee may be considered an aggressive interpretation that is subject to high risk, i.e., high risk of rejection during an audit. As one example, for a non-discrimination test that assesses whether a required minimum distribution is compliant, a test parameter is life expectancy. An interpretation of life expectancy as being very short may be an aggressive or high risk assumption, as the required minimum distribution is greater and money is taken out of the retirement account at a faster than usual rate.

A compliance test, and the subsequent test result, that applies one or more interpretations may have a level of associated risk based on the risk level of the applied one or more interpretations. For example, if multiple high risk interpretations are applied to a compliance test, the compliance test and subsequent test result may be high risk (e.g., likely to be rejected). Various compliance tests may be conducted for a single plan or plan participant (referred to herein as a “series” or “combination” of compliance tests). For example, different compliance tests may be executed for different regulations that govern a single plan. Exemplary compliance tests include, for example, non-discrimination tests, compensation testing, eligibility testing, and benefits, rights, and features tests. A series of compliance tests may be weighted for overall compliance risk, and some high risk tests and/or interpretations may be allowed if there are an adequate number of low risk tests and/or interpretations. In several embodiments, a series of tests has a high risk threshold or quota. In other words, a threshold number of high risk interpretations and/or high risk tests (and results/scores) may be permissible for overall compliance with employee benefit plan regulations. If the high risk threshold or quota has been met, no additional high risk interpretations or high risk tests may be permitted.

In several embodiments, low risk interpretations are applied to a compliance test to achieve a passing compliance test score if there are low risk interpretations available. Since the selection of high risk interpretations is limited, low risk interpretations that allow for a passing compliance test score may be selected unless a high risk interpretation is needed for a passing score. If a high risk interpretation is needed for a passing score, then the high risk interpretation may be selected if the threshold number of allowable high risk interpretations and/or high risk scores has not been met (or the high risk quota has not been met). If the threshold number of allowable high risk interpretations and/or high risk scores has been met and there are no low risk interpretations that allow for a passing score, then the compliance test fails and the plan is considered non-compliant with the associated regulation.

In several embodiments, interpretations of test parameters are associated with risk values or factors. For example, the risk assessment and mitigation module 130 may receive and store data related to different interpretations of test parameters and their associated risk values or factors. As an example, the risk values may be received from a client device (e.g., from a system administrator's user input).

An employee benefit plan compliance test may be associated with a test risk score. The test risk score may be calculated based upon the one or more risk values or factors of the one or more interpretations that are applied to the employee benefit plan compliance test. In several embodiments, a test risk score may be low risk if it has a value that is in a low risk score range or that is above a low risk score threshold value. In several embodiments, a test risk score may be high risk if it has a value that is in a high risk score value range or that is below a high risk score threshold value. In several embodiments, if the test risk score falls between the high risk score threshold value and low risk score threshold value (a high risk grey zone), then overall risk of the compliance test may be dependent on the risks associated with other compliance test(s) that make up the same series of tests as the compliance test under consideration. In these embodiments, the overall risk of the compliance test may be weighted based on test risk score(s) of the other compliance test(s). For example, a test risk score may be aggregated with risk scores of the other compliance tests in the series to determine an average test risk score. If the average test risk score is at or above the low risk threshold value, then the test risk score in the high risk grey zone will be considered low risk. If the average test risk score is below the low risk threshold value, then the test risk score in the high risk grey zone will be considered high risk.

As an example, test risk scores may be assigned values of 1-100, with lower values indicative of higher risk and higher values indicative of lower risk. An exemplary low risk threshold value may be 60, with values at or above the low risk threshold value being low risk values. An exemplary high risk threshold value may be 35, with scores at or below 35 considered high risk. Scores between 35 and 60 may be in the high risk grey zone. For example, a score of 42 is in the high risk grey zone.

In the above example, whether the score of 42 is high risk or low risk depends on the other test risk scores for tests in the series. As a non-limiting example, a series of ten compliance tests are conducted for a plan. Using the exemplary numbers above, five of tests have a test risk score above 60 (e.g., 63, 72, 78, 81, 82) and are low risk, while four of the tests have a test risk score below 35 (e.g., 31, 28, 20, 15) and are high risk. To determine whether the test risk score of 42 of the tenth test is high risk, an average test risk score may be determined based on the aggregate of the test scores. In this example, the average test risk score is 51.2, which is below the low risk threshold value, and the tenth test score of 42 will be considered high risk. If the average test risk score was above 60, the tenth test score would be considered low risk. The above example and equation is meant to be exemplary and other means of weighting compliance scores is contemplated.

In some embodiments, the risk assessment and mitigation module 130 selects from different pools or selections of interpretations to incorporate risk into the compliance and risk analysis. For example, interpretations may be divided into high risk interpretations and low risk interpretations. The risk assessment and mitigation module 130 may select interpretations from the high risk interpretations pool when necessary to achieve a passing compliance score. For example, various combinations of interpretations may be tested with an employee benefit plan compliance test for compliance. If no or only some low risk interpretations achieve a passing compliance score, then high risk interpretations will be selected to achieve a passing compliance score. High risk interpretations may be selected from the high risk interpretations pool until no high risk interpretations remain. In other words, the risk assessment and mitigation module 130 may apply conservative (or low risk) interpretations to achieve passing compliance scores and may apply high risk interpretations when needed to achieve a passing compliance score. By having a finite pool of high risk interpretations, the risk assessment and mitigation module 130 may avoid making too many high risk compliance analyses that are likely to be rejected by the regulating body (e.g., the IRS) as being non-compliant overall.

The compliance test optimization module 128 and the risk assessment and mitigation module 130 may work together to determine the applicable interpretations and combinations of interpretations to achieve a passing compliance score while mitigating risk. In several embodiments, the compliance test optimization module 128 determines which interpretation(s) or combinations of interpretations can be applied to a compliance test to achieve a passing test score. The interpretations that result in a passing test score are referred to herein as “passing interpretations.” In these embodiments, the risk assessment and mitigation module 130 determines which of the passing interpretation(s) or combinations of passing interpretations are permissible based on their associated risk and, in some instances, the overall risk tolerance or quota for the series of compliance tests.

The data storage device 120 of FIG. 2 may be an external component of the system 100 or integrated into one or more of the system 100 components. As used herein, a “module” includes a general purpose, dedicated or shared processor and, typically, firmware or software modules that are executed by the processor. Depending upon implementation-specific or other considerations, the module can be centralized, or its functionality distributed. The module can include general or special purpose hardware, firmware, or software embodied in a computer-readable (storage) medium for execution by the processor. One or more of the disclosed modules may be implemented on the same machine or distributed among different machines.

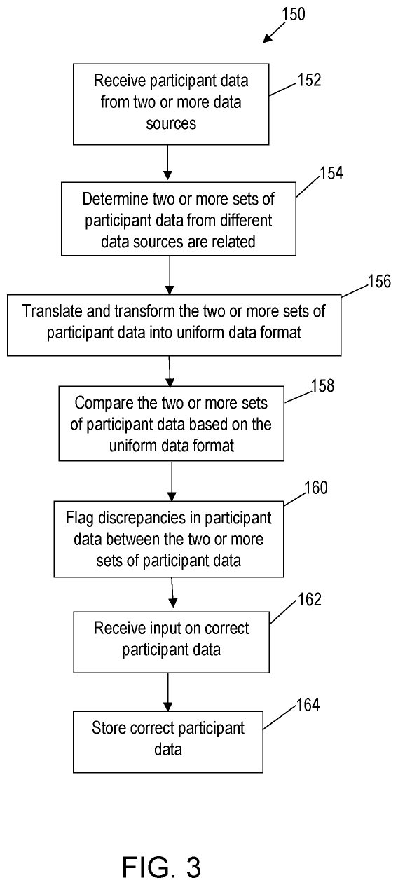

FIG. 3 is a flow chart illustrating a method of validating participant data. The method 150 begins with operation 152 and participant data is received from two or more data sources. The participant data may be in varying formats, including for example, source code, forms or other documents, spreadsheets, tables, and the like. The participant data may be associated with a plurality of participants and plans. For example, the participant data may be associated with a company's employees who participate in the company's employee benefit plans, which could be a couple employees and associated participant data to thousands of employees and associated participant data.

After operation 152, the method 150 may proceed to operation 154, and the system may determine two or more sets of participant data from different data sources are related. For example, two sets of participant data may come from two different data sources and be associated with a single participant or plan. The system may determine the two sets of data are related based on a common identifier associated with the two sets of data. For example, the two sets of data may be labeled with the same participant or plan name. If the names differ, e.g., based on differing naming systems between the two different data sources, the system can determine the same name is intended by translating, mapping, or transforming the differing names into a uniform language or format, as discussed in more detail above.

After operation 154, the method 150 may proceed to operation 156 and the participant data of the two or more related participant data sets is translated and transformed into a uniform data format. As discussed, the same data set or related data set may be named or labeled differently by the different data sources, making it difficult to compare like data. The data may be translated by determining a uniform data format that is associated with the data in the two or more related participant data sets. The two or more related participant data sets may be transformed into the uniform data format in the same manner as discussed above with respect to the data CTT module 122 of FIG. 2. For example, the data may be renamed with a uniform language, mapped to a uniform data structure, or tagged with an identifier indicative of the type of data.

After operation 156, the method 150 may proceed to operation 158 and the participant data of the two or more related participant data sets is compared based on the uniform data format, language, or tags/identifiers. For example, based on the tags or uniform format, the same or similar data can be identified and compared. For example, elective deferral data from one source (e.g., a recordkeeper) may be compared to elective deferral data from another source (e.g., a plan provider or sponsor), while pre-tax contribution data from one source may be compared to pre-tax contribution data from another source. The data may be compared in the same manner as discussed above with respect to the data validation module 124 of FIG. 2.

After operation 158, the method 150 may proceed to operation 160 and discrepancies in the participant data of the two or more participant data sets may be flagged. For example, if the same data entry for the same plan or participant from different data sources has different values or otherwise differing information, the data entries may be flagged as including an error. For example, if the elective deferral amount from the recordkeeper is $1600 and the elective deferral amount from the plan sponsor is $1500, then the discrepancy in the elective deferral amount will be flagged as an error.

After operation 160, the method 150 may proceed to operation 162 and input on correct participant data may be received. For example, the system may alert one or more of the third-party data sources of the discrepancy in participant data, providing them with the opportunity to review and correct the error or confirm which data entry is correct. User input may be received from a client device providing the correct data and resolving the discrepancy in data. It is contemplated that the correct participant data may be determined by the system, as described in more detail with respect to the data validation module 124 of FIG. 2.

After operation 162, the method 150 may proceed to operation 164 and the correct or validated participant data may be stored. The system may store validated participant data in a database. Such data may be used to conduct the various compliance tests described herein. Such data may also be used to fill out forms required by a governing or regulating body, such as the IRS or DOL (e.g., form 5500), for data reporting and/or compliance purposes. It is contemplated that the method 150 may be implemented by the data validation module 124 of FIG. 2 or other system 100 components.

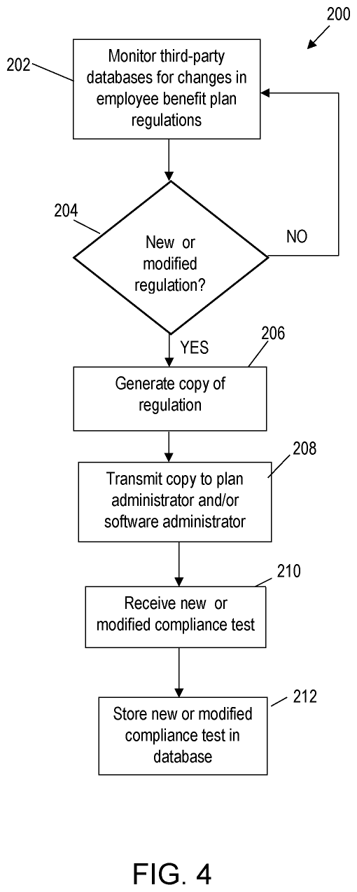

FIG. 4 is a flow chart illustrating a method of monitoring changes in employee benefit plan regulations. The method 200 begins with operation 202 and third-party databases may be monitored for changes in employee benefit plan regulations. The databases may be monitored based on employee benefit plan and compliance key words and/or applicable statutes (e.g., 29 USC Chapter 18 (ERISA), 26 USC § 401 related to tax treatment, the SECURES Act, the CARES ACT, EGGTRA, USERRA, TEFRA, the PPA, etc.). The databases may be monitored in a similar manner as described above with respect to the data monitoring module 126 of FIG. 2.

After operation 202, the method 200 may proceed to operation 204 and the system determines whether a new or modified regulation has been issued. For example, the system may detect new or modified language or a new rule number and determine a new or modified regulation has been issued. If no new or modified regulation has been issued, the method 200 may proceed to operation 202 and the third-party databases may be monitored for changes in regulations. If a new or modified regulation has been issued, the method 200 may proceed to operation 206 and a copy of the new or modified regulation is generated (e.g., a screenshot or PDF or the like).

After operation 206, the method 200 may proceed to operation 208 and the copy of the new or modified regulation may be transmitted to a client device associated with a plan administrator and/or software administrator. The plan administrator and/or software administrator may interpret the new or modified regulation to form a new or modified compliance test. Alternatively, operation 206 may be omitted and instead an alert transmitted to the client device providing information on the new or modified regulation, and, in some instances, any associated compliance tests.

After operation 208, the method may proceed to operation 210 and the new or modified compliance test may be received (e.g., from the client device).

After operation 210, the method 200 may proceed to operation 212 and the new or modified compliance test may be stored in a database. For example, the new or modified compliance test may be stored with the other compliance tests as part of a series or grouping of compliance tests related to employee benefit plan compliance. It is contemplated that the method 200 may be implemented by the data monitoring module 126 of FIG. 2 or other system 100 components.

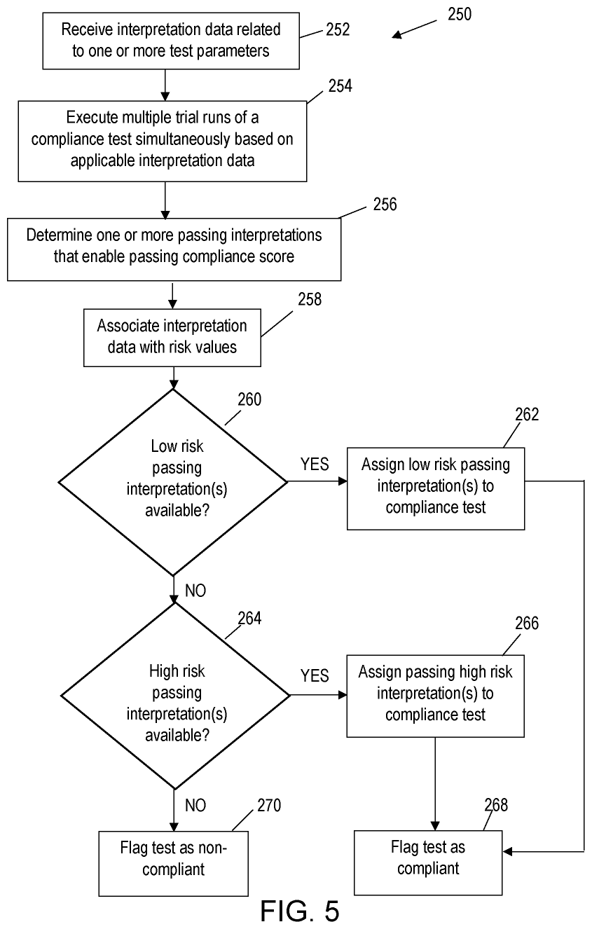

FIG. 5 is a flow chart showing a method of optimizing employee benefit plan compliance while minimizing risk. The method 250 begins with operation 252 and interpretation data related to one or more test parameters may be received. Test parameters may include the data points analyzed by the various compliance tests, including compensation types, deferral amounts, pre-tax contribution amounts, post-tax contribution amounts, benefits, fringe benefits, total income, total investments, total distributions, and the like. Test parameters may have various interpretations (e.g., what constitutes a “distribution”) that are acceptable by the regulating bodies (e.g., the IRS and DOL). Some test parameter interpretations may be more acceptable than others (and therefore lower risk). Interpretations of test parameters may be received from various third parties or third-party data sources, including the IRS, the DOL, legal research entities (e.g., LexisNexis®, Westlaw®, etc.), treatises, and the like. It is contemplated that the interpretations of test parameters may be stored in a database and retrieved from the database at operation 252.

After operation 252, the method 250 may proceed to operation 254 and multiple trial runs of a compliance test may be executed simultaneously based on applicable interpretation data. For example, multiple non-discrimination tests may be executed simultaneously that apply different interpretations of one or both of “total employer match” and “employee's total compensation,” the test parameters of the ACP test. If “total employer match” has 9 different interpretations and “employee's total compensation” has 12 different interpretations, the different combinations of interpretations can be numerous. A different compliance test may be executed for each possible combination.

After operation 254, the method 250 may proceed to operation 256 and one or more passing interpretations are determined that enable a passing compliance score. The one or more passing interpretations may be determined in a similar manner as described above with respect to the compliance test optimization module 128 of FIG. 2.

After operation 256, the method 250 may proceed to operation 258 and the interpretation data may be associated with risk values. As discussed, some interpretations may be higher risk than others, and may be assigned higher risk values. For example, a high risk value could be assigned a low numerical value (e.g., under 30) and a low risk value could be assigned a high numerical value (e.g., above 70) (or vice versa). The risk values may be assigned to the different interpretations by a system operator and stored by the system. It is contemplated that the risk values may be associated with the interpretations prior to determining passing interpretations such that when the passing interpretations are determined at operation 256, they are already associated with risk values.

After operation 258, the method 250 may proceed to operation 260 and the system determines whether one or more low risk passing interpretations are available to contribute to a passing score. If one or more low risk passing interpretations are available, the method 250 may proceed to operation 252 and the one or more low risk passing interpretations are assigned to the compliance test. The method 250 may proceed to operation 268 and the test is flagged as compliant.

If no low risk passing interpretations are available, the method 250 may proceed to operation 254 and the system determines whether one or more high risk passing interpretations are available to contribute to a passing score. High risk passing interpretations may be unavailable if no high risk interpretations resulted in a passing compliance test score or if high risk passing interpretations were applied to other compliance tests in the series of tests. As discussed, a finite amount of high risk interpretations may be allowed, such that no high risk interpretations may be available for future compliance tests when other compliance tests in the series of test have used all available high risk interpretations.

If one or more high risk passing interpretations are available, the method 250 may proceed to operation 266 and the one or more high risk passing interpretations are assigned to the compliance test. The method 250 may proceed to operation 268 and the test is flagged as compliant. If no high risk passing interpretations are available, the method 250 may proceed to operation 270 and the test is flagged as non-compliant.

The system 100 may use the data received or determined by the system 100 for audit purposes, quality control, and/or data reporting (e.g., 5500 form submission with the IRS). The determination of whether certain compliance tests are passing or not and their associated risk values may be stored as compliance data. This compliance data may be referenced in case of an audit, for example, by the IRS.

As one example, the system 100 may automatically populate a 5500 form with the validated data determined by the data validation module 124. By using the validated data, errors in 5500 form submission can be avoided, mitigating IRS audits and improving compliance. The 5500 form inputs may include test parameters that have been tested by the system 100 for compliance by the compliance optimization module 128 and for risk by the risk assessment and mitigation module 130. By testing the parameters input into the 5500 form for compliance and risk before submitting the 5500 form, the system 100 mitigates non-compliance.

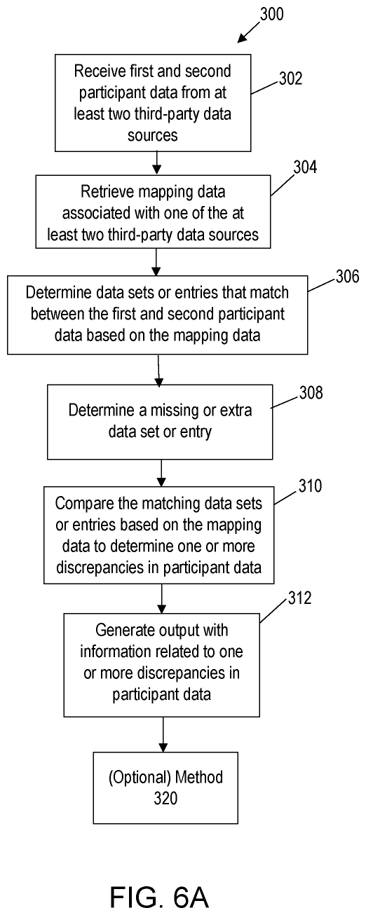

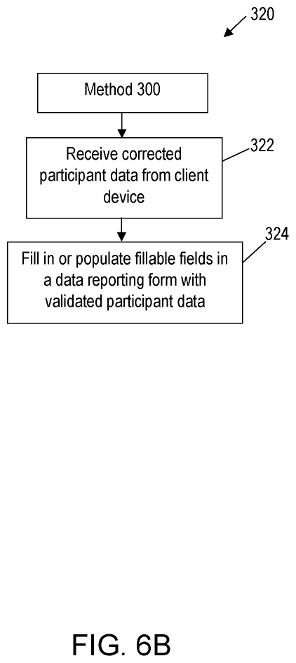

FIG. 6A is a flow chart illustrating a method of validating participant data for improved accuracy of employee benefit plan compliance. The method 300 begins with operation 302 and the system (e.g., system 100) receives first and second participant data from at least two third-party data sources. The at least two third-party data sources may include a recordkeeper, a plan sponsor or provider or employer, an insurance provider, a financial institution, a trustee, a fiduciary (e.g., a 3(16) fiduciary), a payroll vendor, a TPA, and the like. For example, the first participant data may be input by or received from a plan sponsor and the second participant data may be input by or received from a record keeper.

The first participant data may be input directly into the system via a client device. The first participant data may be input via a user interface having fillable fields, such that the data is in a system format readily digestible by the system. For example, the system may compile the first participant data received into a data table (e.g., in CSV or Excel format) having rows and columns, the rows associated with plan participants or plan participant data entries and the columns associated with different participant data parameters (e.g., census parameters) (or vice versa). In some embodiments, the first participant data may be ingested or received by another system or software application and transmitted to the disclosed system (e.g., system 100). In these embodiments, the other system or application may compile the first participant data received into the data table described above or into an Excel or CSV file and transmit the data table or Excel or CSV file to the disclosed system. Participant data may include census data. Participant data parameters may include, for example, name (first, middle, last), plan ID, year end date, address (Street, City, State, Zip), date of birth, email address, social security number, hire date, termination date, rehire date, plan entry date, highly compensated employee status, key employee status, gross salary amount, overtime amount, annual hours, bonus amount, commission amount, cafeteria contribution amount, 403(b) contribution amount, 401(k) contribution amount, Roth contribution amount, employer match contribution amount, safe harbor match contribution amount, safe harbor non-elective contribution amount, employer profit sharing contribution amount, ownership percentage, voting percentage, officer, and the like. Participant data parameters include parameters that are relevant for employee benefit plan compliance testing.

The second participant data may be received in a unique data format or non-system data format (e.g., different from the data format created by the system for the first participant data). The second participant data format may be a data table, a CSV file, or an Excel file. For example, the data format may include rows that may be associated with plan participants or plan participant data entries and columns that may be associated with different parameters (or vice versa). The parameters may be the same or may vary from the parameters in the system's data table. The column locations of parameters may vary from the column locations of the parameters in the system's data table. For example, social security number may be in column 3 in the system data table for the first participant data and in column 8 in the non-system data table for the second participant data. It is also contemplated that the parameter data values or inputs may have different formats or labels. For example, participant gender may be M for male and F for female in the system, and 1 for male and 2 for female in the non-system data format.

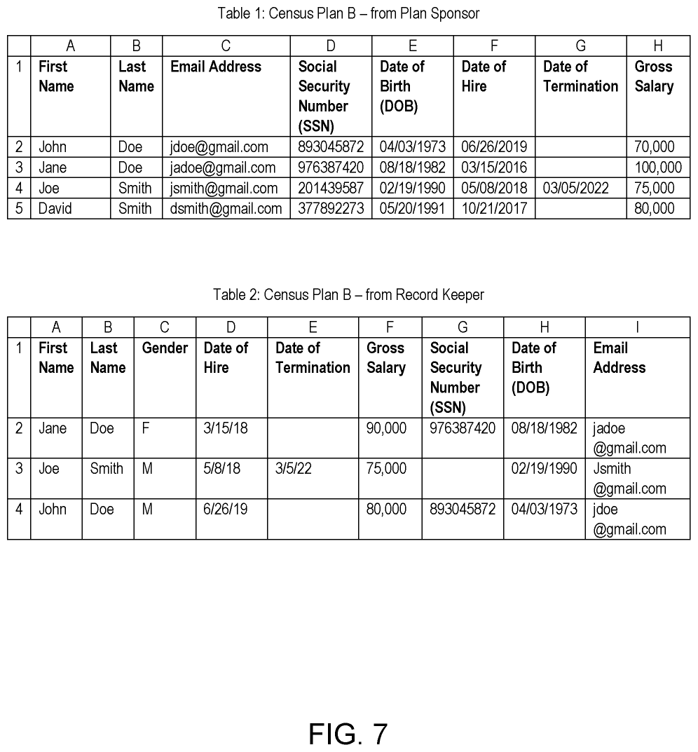

FIG. 7 shows exemplary data formats for participant data received from two different third-party data sources. In this example, participant data for a plan labeled “Census Plan B” is received from a plan sponsor (Table 1) and from a record keeper (Table 2). The participant data is in a data table format with rows associated with different plan participants or data entries and columns associated with different census parameters. It is also contemplated that the rows may be associated with different census parameters and the columns associated with different plan participants or data entries. In the depicted embodiment, Table 1 has 5 rows and 8 columns and Table 2 has 4 rows and 9 columns. Table 1 may be generated by the system based on input received from the plan sponsor via a graphical user interface on a client device. The table may automatically populate based on the user input received. The parameters in the columns may be relevant for employee benefit plan compliance testing.

As shown, the data structure of Table 2 varies from that of Table 1 and some of the inputs are in a different format. For example, Table 2 has an extra column for gender, which is not included in Table 1, and the same parameters (e.g., date of hire, date of termination, gross salary, SSN, DOB, and email address) are in different columns. As another example, the date format in Table 1 is MM/DD/YYYY, including zeros for single digit numbers, while the date format in Table 2 is MM/DD/YY, excluding zeros for single digit numbers.

Returning to FIG. 6A, after operation 302, the method 300 may proceed to operation 304 and mapping data may be retrieved that is associated with at least one of the at least two third-party data sources. Mapping data may also be referred to as a mapping template or data entry routine (DER). Mapping data or a mapping template may map data from a non-system data format to a system data format. For example, the mapping data or mapping template may indicate the type of parameter data that is in each data entry (e.g., in each column) of the non-system data format. Mapping data may be input by a system administrator when a new data format is received and stored by the system in memory storage. For example, a new third-party data source may provide data in a new data format. A system administrator may input into the system locations of parameters that correspond to parameters in the system participant data architecture, instructions to skip over parameters that do not correspond to parameters in the system participant data architecture (e.g., parameters that are not relevant for employee benefit plan compliance testing), and variations in parameter data input formats (e.g., 1 for Yes vs. Y for Yes), if different from the system's parameter data input formats.

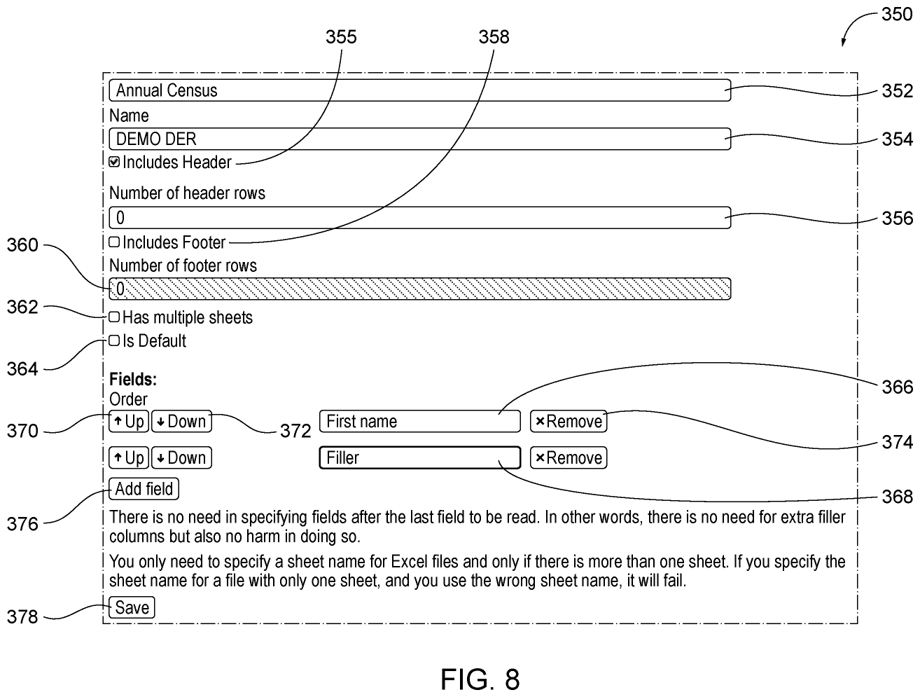

FIG. 8 shows an exemplary graphical user interface 350 that may be used by a system administrator to input mapping data. As shown, the data input fields include data map type 352, data map name 354, includes header 355, number of header rows 356, includes footer 358, number of footer rows 360, has multiple sheets 362, Is Default 364, Field 1 366, Field 2 368, Order Up 370, Order Down 372, Remove 374, Add Field 376, and Save 378. The data map name 354 may include the name of the third-party data source. The includes header 355 and includes footer 358 options may be selected or unselected, depending on whether the non-system data format includes a header or footer row or rows. If the option is selected, the number of header rows 356 or number of footer rows 360 may be input into the system. In the example non-system data format shown in Table 2 of FIG. 7, the data format includes a single header row of the census parameters. In this example, the includes header 355 option would be selected and a value of 1 would be input into number of header rows 356. With information on the number of header rows, the system can skip or ignore the header rows and avoid importing them as a participant data entry. The data input “has multiple sheets” 362 may be selected if there are multiple sheets or pages in the data format (e.g., more than one sheet in an Excel spreadsheet). Is Default 364 may be selected if the format of the data input (e.g., an Excel format or CSV format) is in a default setting (e.g., a single sheet).

The “Fields” section may receive user input indicating the ordering of parameters in the non-system data format. In the example shown, Field 1 366 is labeled with parameter “first name” and Field 2 368 is labeled “filler.” In this example, the data input in Field 1 366 indicates that the first column (or row) in the non-system data format is associated with the first name parameter. The “filler” data input provides instructions to the system to skip a column or row. For example, a parameter included in the non-system data format may be omitted in the system data format and may therefore be skipped over when mapping the non-system data format to the system data format. The fields may be moved up or down by selecting the Order Up 370 button or Order Down 372 button, respectively, for example to reorder the fields or parameters in order of how they appear in the non-system data format. A field may also be removed by selecting the Remove 374 button. A field may be added by selecting the Add Field 376 button. For example, fields may be added to match the number of fields in the non-system data format. The Save 378 button may be selected to save the mapping data in the system database for future retrieval by the system.

In the example depicted in FIG. 7, to create mapping data for the record keeper participant data displayed in Table 2, an administrator may input from Table 2 First Name in Field 1 366 and Last Name in Field 2 368. The administrator may select Add Field to add the additional columns in the order they appear in Table 2. The next field after Field 2 (e.g., Field 3) may be input as “filler” since the gender parameter does not appear in the system data table, Table 1. For example, gender may not be relevant to employee benefit plan compliance testing. By inputting “filler” into Field 3, the gender column may be skipped over when mapping the data in Table 2 to the data in Table 1.

It is contemplated that the data parameter values or inputs may be labeled, tagged, or coded differently in the non-system data format. When creating the mapping data, the system administrator may mark data having a different label or tag with a uniform tag or label to correspond with the labels or tags in the system data format. For example, a data input of “yes” may be labeled or tagged as “1” by a non-system data format and labeled or tagged as “yes” by the system data format. The mapping data may indicate that a “1” in a particular column (associated with a particular parameter) is the same as the “yes” input.

The mapping data may be stored by the system in a system database associated with the third-party data source and retrieved by the system in operation 304 of method 300.

Returning to FIG. 6A, after operation 304, the method 300 may proceed to operation 306 and the system may determine participant data sets or entries that match between the first and second participant data based on the mapping data and matching identifiers within the first and second participant data. An identifier may identify a different participant data set or entry. An exemplary identifier within the first and second participant data may be social security number since it is different for each participant data set or entry. For example, participant data sets or entries match for the same participant when the social security numbers match. Another exemplary identifier is first and last name. In the example depicted in FIG. 7, the mapping data may map the parameter social security number in Table 2 to column G. The system may scan through the data inputs in column G for inputs that match the data input in columns D of Table 1, respectively, which is also associated with the parameter social security number. For example, the system may determine that rows 2, 3, and 4 of Table 1 match rows 4, 2, and 3 of Table 2, respectively. It is also contemplated that the system may use different identifiers, such as matching the names in columns A and B.

After operation 306, the method 300 may proceed to operation 308 and the system may determine that there is a missing or extra data set or entry when a matching participant data set or entry is missing or an extra one exists that does not match. In the example shown in FIG. 7, the system may determine that the participant data entry in row 5 of Table 1 is missing from Table 2. For example, the system may not locate a matching data entry that includes David in Column A and Smith in Table B and flag this participant data entry as missing from Table 2.

After operation 308, the method 300 may proceed to operation 310 and the matching participant data sets or entries may be compared based on the mapping data to determine one or more discrepancies in the participant data. In the example depicted in FIG. 7, the system may compare the data inputs in Table 1, row 2 with Table 2, row 4; Table 1, row 3 with Table 2, row 2; and Table 1, row 4 with Table 2, row 3. Based on the mapping data, the system recognizes that Table 2, column D corresponds with Table 1, column F; Table 2, column E corresponds with Table 1, column G; Table 2, column F corresponds with Table 1, column H; Table 2, column G corresponds with Table 1, column D; Table 2, column H corresponds with Table 1, column E; and Table 2, column I corresponds with Table 1, column C. The system compares the data inputs in the matching participant data sets (the matching rows) that are in corresponding columns to determine discrepancies. For example, the system may compare the data inputs in Table 1, row 2 with the data inputs in Table 2, row 4. When the system compares the data input in Table 1, column H with the data input in Table 2, column F according to the mapping data, the system may determine that there is a discrepancy in the gross salary since the values do not match ($70,000 in Table 1 compared to $80,000 in Table 2). The system may simultaneously compare the data inputs in Table 1, row 3 with the data inputs in Table 2, row 2. When the system compares the data input in Table 1, column F with the data input in Table 2, column D, the system may determine that there is a discrepancy in the date of hire data since the data inputs (the dates) do not match. In this example, the date of hire in Table 1 is in 2016, while the date of hire in Table 2 is in 2018. Further, when the system simultaneously compares the data input in Table 1, column H with Table 2, column F, the system may determine that there is a discrepancy in the salary amount since the data inputs do not match ($100,000 in Table 1 vs. $90,000 in Table 2). The system may further simultaneously compare the data inputs in Table 1, row 4 with the data inputs in Table 2, row 3. When the system compares the data input in Table 1, column D with the data input in Table 2, column G, the system may determine that here is a discrepancy in the data. In this case, the system may determine that the data input is omitted in Table 2.

After operation 310, the method 300 may proceed to operation 312 and the system may generate an output with information related to one or more discrepancies in the participant data. The output may be displayed as one or more of a report, a table, an Excel spreadsheet, and the like. The output may be displayed instantaneously (e.g., in real-time or within seconds) after both data sets (e.g., both the first and second participant data) are received by the system. The system may transmit an email or notification to the system administrator providing the report or indicating that the report has been created and errors were found.

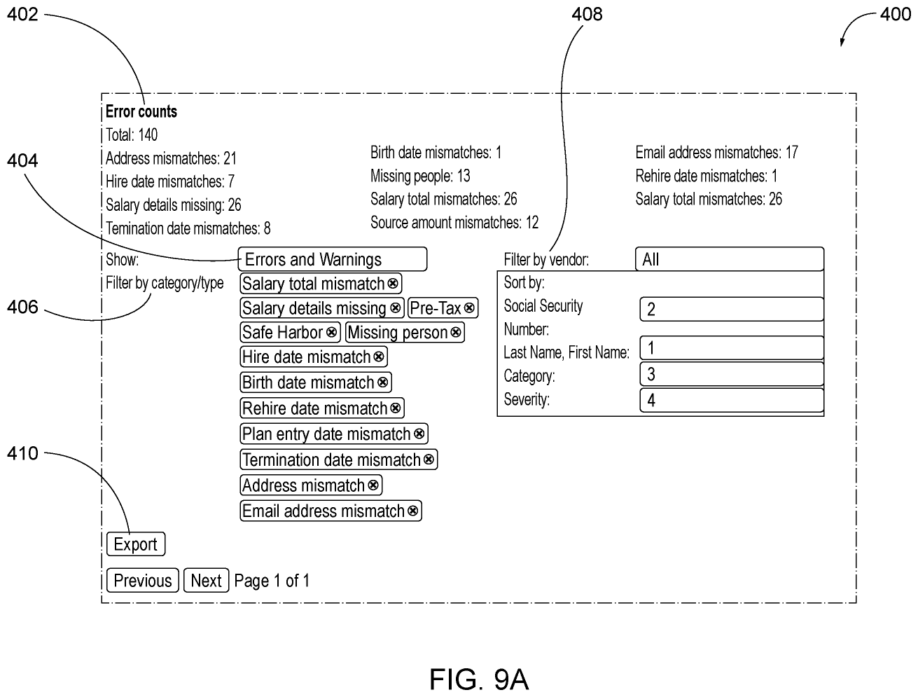

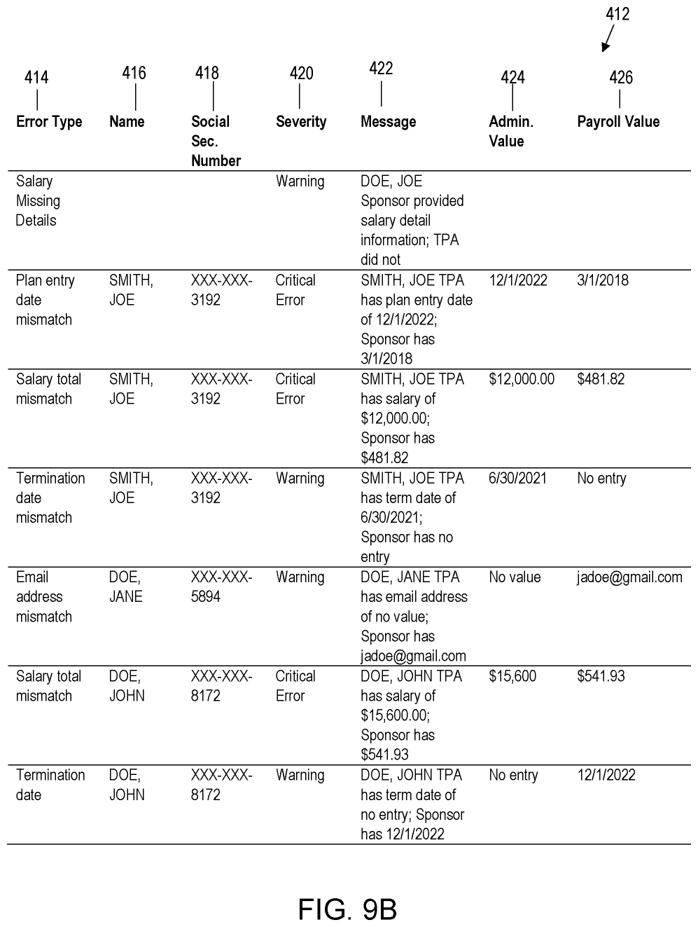

FIGS. 9A-B show a graphical user interface of a client device displaying an exemplary output of discrepancy or error data, which includes data related to discrepancies or errors in the participant data. FIG. 9A shows a first portion of the exemplary output of discrepancy or error data. FIG. 9B shows a second portion of the output of FIG. 9A. As shown, a report 400 is generated and displayed on a graphical user interface of a client device. The report 400 provides information related to discrepancies or mismatches in the participant data. As shown, the report 400 displays information related to error or warning types and counts. An error may be a critical error that needs to be resolved for proper compliance testing. For example, an error may be a discrepancy in a parameter input or value for a parameter that impacts valid compliance testing. Examples of such parameters that impact valid compliance testing include parameters related to participant name, compensation (e.g., salary, bonus, commission, overtime), monetary contributions (403(b) contribution amount, 401(k) contribution amount, Roth contribution amount, employer match contribution amount, safe harbor match contribution amount, safe harbor non-elective contribution amount, employer profit sharing contribution amount), work hours and time (e.g., hire date, rehire date, termination date, hours, overtime hours, etc.), and the like. A warning may be a discrepancy in a parameter input or value for a parameter that does not impact valid compliance testing. Examples of such parameters that do not impact valid compliance testing include personal information, such as address and email address, term date, and the like.

In the exemplary report 400, the error counts are displayed, showing a total of 140 errors detected in the comparison of the participant data, including 21 address mismatches, 7 hire date mismatches, 26 salary details missing, 8 termination date mismatches, 1 birth date mismatch, 13 missing people or missing participant data entries, 26 salary total mismatches, 12 source amount mismatches, 17 email address mismatches, 1 rehire date mismatch, and 26 salary total mismatches.

The information displayed in the report 400 can be filtered. For example, an administrator can filter between errors, warnings, or both for display in the report 400 with the errors and warnings filter 404. An administrator can also adjust the filter by category/type 406 to display particular parameters that are mismatched and filter others out of the report 400. In the example shown, the system is instructed to display errors and warnings related to salary total mismatch, salary details missing, pretax, safe harbor, missing person, hire date mismatch, birth date mismatch, rehire date mismatch, plan entry date mismatch, termination date mismatch, address mismatch, and email address mismatch. An administrator can also adjust the filter by vendor 408 to display in the report 400 plan information from particular third-party data sources. In the example depicted, the system is instructed to display errors from all vendors. An administrator may select the Export button 510 and the system may export the report 400 with discrepancy data according to the selected filters. For example, the report 400 may be exported as an Excel spreadsheet.

FIG. 9B shows detailed information displayed in the report 400 based on the filter selections. As shown, the detailed information is displayed in a table 412. The table 412 displays information related to error type 414, name 416, social security number 418, severity 420, message 422, administrator value 424, and payroll 426. The error type 414 includes the parameter that is mismatched, including, for example, salary details missing, plan entry date mismatch, salary total mismatch, termination date mismatch, email address mismatch, and the like. The name 416 and social security number 418 provide personal details for the participants to identify the participant data entry that includes the error or mismatched data. The severity 420 provides information on whether the error or mismatch is a critical error or a warning. The message 422 provides additional details related to the error or mismatch. For example, the message 422 may include information on which third-party data source has which participant data input or value. As an example, the message 422 may indicate that the sponsor provided salary detail information while the TPA did not. The administrator value 424 may indicate the data value or input that was provided from the administrator (e.g., a TPA or third-party vendor in a non-system data format) for the mismatched parameter. The payroll value 426 may indicate the data value or input that was provided from the plan sponsor (e.g., that was entered into the system in the system data format) for the mismatched parameter. There may be multiple errors or mismatched parameters for a single participant data entry, which may be displayed as multiple rows in the table 412.

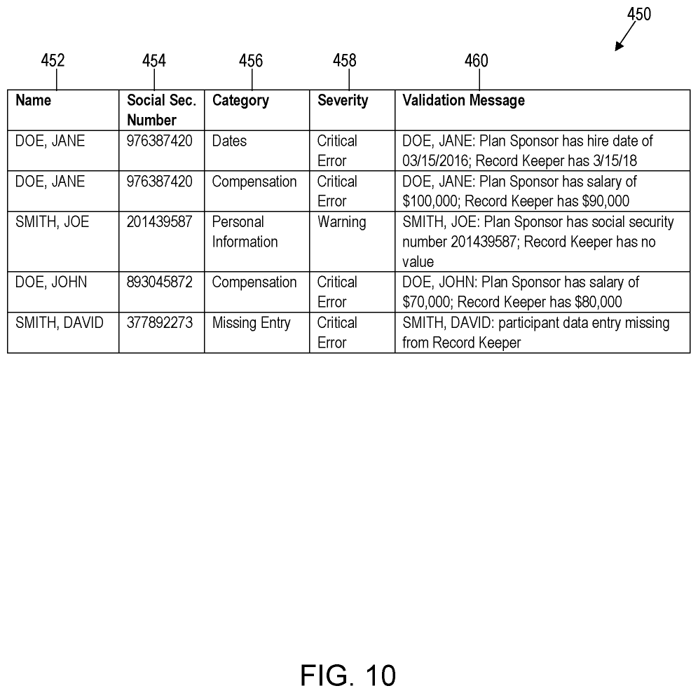

FIG. 10 shows an image of an exemplary exported data table 450, which may be included in an Excel spreadsheet format. The mismatched data presented in exported data table 450 shows mismatched data between the participant data provided by the Plan Sponsor in Table 1 of FIG. 7 and the participant data provided by the Record Keeper in Table 2 of FIG. 7, showing the participant data entry that includes the mismatched participant data or parameter inputs and specifying the mismatch or discrepancy detected. As shown, the exported data table 450 may include a column for Name 452, Social Security Number 454, Category 456, Severity 458, and Validation Message 460. The Name 452 and Social Security Number 454 identify the participant data entry that includes the error or mismatched participant data input. As shown, if there are multiple participant data inputs that are mismatched for a participant data entry, they are presented as different rows in the exported data table 450. For example, the participant data entry for Jane Doe has two mismatched parameter inputs, which appear as two rows in exported data table 450. The Validation Message 460 explains the type of error detected. For example, the system detected that the hire date for Jane Doe is mismatched, with the Plan Sponsor hire date on Mar. 15, 2016 and the Record Keeper hire date on Mar. 15, 2018, and the salary for Jane Doe is also mismatched, with the Plan Sponsor salary at $100,000 and the Record Keeper salary at $90,000. The system also detected that the social security number for Joe Smith is missing from the Record Keeper participant data, that the salary for John Doe is mismatched, with the Plan Sponsor salary at $70,000 and the Record Keeper salary at $80,000, and that the participant data entry for David Smith is missing from the Record Keeper.

The exported data table 450 may include filtering functions to filter out unnecessary or unwanted information. For example, the Severity 458 column may include a toggle to filter between critical errors and warnings. For example, only critical errors may be displayed in the exported data table 450.

Returning to FIG. 6A, the method 300 may optionally proceed to method 320 of FIG. 6B. FIG. 6B is a flow chart illustrating a method 320 of generating a pre-validated data reporting form. The method 320 may begin with method 300 and operations 302-312 may be performed in the same or similar manner as described with respect to FIG. 6A. After operation 312, the method 320 may proceed to operation 322 and corrected participant data may be received from a client device or other system or database. For example, a user or system administrator may transmit information related to the discrepancies or errors in participant data to one or both of the third-party data sources for correction. In some embodiments, the third-party data source may provide an updated participant data file that includes both the correct participant data and corrected participant data. The correct participant data may be participant data that included matching parameter inputs or values between the two data sets (e.g., participant data for which no errors or discrepancies were found). The corrected participant data may include participant data that corrects the discrepancies or errors. The correct participant data and corrected participant data may be collectively referred to as “validated data.” The updated or validated participant data may be received in a CSV or Excel file or other table format. In other embodiments, the user or administrator may input the corrected participant data into the system via a client device. In these embodiments, the corrected participant data may be aggregated or combined with the correct participant data to produce validated participant data. The corrected participant data and correct participant data may be stored as validated participant data in a database.

After operation 322, the method 320 may proceed to operation 324 and the system may fill in or populate fillable fields in a data reporting form with the validated participant data. A data reporting form may be any fillable form used to report relevant participant data to a regulating or government body for employee benefit plan compliance testing. For example, the data reporting form may be a Form 5500 Series form. Employee benefit plans use the Form 5500 Series forms to satisfy annual reporting requirements under Title I and Title IV of ERISA and under the Internal Revenue Code. By populating a data reporting form, such as the Form 5500 Series form, with validated participant data, errors in annual reporting and disclosure can be mitigated or avoided, thereby improving compliance.

By data mapping and comparing multiple participant data entries simultaneously based on the mapping data, the system is able to produce a list of mismatched participant data from the different third-party data sources much more quickly than prior systems for validating participant data. By detecting mismatched participant data, such errors in the participant data can be corrected for more accurate participant data. The more accurate participant data can be used in plan compliance testing, producing an overall compliance result that is more accurate and less likely to be rejected by the IRS. Once the system receives the corrected participant data, the system may automatically fill in a data reporting form with the accurate plan or participant data. In this manner, the system is able to produce a more accurate data reporting form, mitigating audits and improving compliance.

A simplified block structure for computing devices that may be used with the system 100 or integrated into one or more of the system 100 components is shown in FIG. 11. For example, the client device(s) 102 and/or server(s) 104 may include one or more of the components shown in FIG. 11 and be used to execute one or more operations. With reference to FIG. 11, the computing device 500 may include one or more processing elements 502, an input/output interface 504, feedback components 506, one or more memory components 508, a network interface 510, one or more external devices 512, and a power source 514. Each of the various components may be in communication with one another through one or more busses, wireless means, or the like.

The local processing element 502 is any type of electronic device capable of processing, receiving, and/or transmitting instructions. For example, the local processing element 502 may be a central processing unit, microprocessor, processor, or microcontroller. Additionally, it should be noted that select components of the computing device 500 may be controlled by a first processor and other components may be controlled by a second processor, where the first and second processors may or may not be in communication with each other.

The one or more memory components 508 are used by the computing device 500 to store instructions for the local processing element 502, as well as store data, such as the participant data, mapping data, regulations data, compliance test data, test parameter interpretation data, risk data, historical third-party data, and the like. The one or more memory components 508 may be, for example, magneto-optical storage, read-only memory, random access memory, erasable programmable memory, flash memory, or a combination of one or more types of memory components.

The one or more feedback components 506 may provide visual, haptic, and/or auditory feedback to a user. For example, the one or more feedback components may include a display that provides visual feedback to a user and, optionally, can act as an input element to enable a user to control, manipulate, and calibrate various components of the computing device 500. The display may be a liquid crystal display, plasma display, organic light-emitting diode display, and/or cathode ray tube display. In embodiments where the display is used as an input, the display may include one or more touch or input sensors, such as capacitive touch sensors, resistive grid, or the like.

The I/O interface 504 allows a user to enter data into the computing device 500, as well as provides an input/output for the computing device 500 to communicate with other devices (e.g., the client device(s) 102, the one or more servers 104, other computers, etc.). The I/O interface 504 can include one or more input buttons, touch pads, and so on.

The network interface 510 provides communication to and from the computing device 500 to other devices. For example, the network interface 510 allows the one or more servers 104 to communicate with the one or more client devices 102 through the network 106. The network interface 510 includes one or more communication protocols, such as, but not limited to WiFi, Ethernet, Bluetooth, and so on. The network interface 510 may also include one or more hardwired components, such as a Universal Serial Bus (USB) cable, or the like. The configuration of the network interface 510 depends on the types of communication desired and may be modified to communicate via Wifi, Bluetooth, and so on.

The external devices 512 are one or more devices that can be used to provide various inputs to the computing device 500, e.g., wearable device, microphone, trackpad, or the like. The external devices 512 may be local or remote and may vary as desired.

The power source 514 is used to provide power to the computing device 500, e.g., battery, electrical outlet, or the like. In some embodiments, the power source 514 is rechargeable; for example, contact and contactless recharge capabilities are contemplated. In some embodiments, the power source 514 is a constant power management feed. In other embodiments, the power source 514 is intermittent (e.g., controlled by a power switch or activated by an external signal). The power source 514 may include an auxiliary power source.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order and that operations can be omitted, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as described herein.

We claim:

1. A method for optimizing employee benefit plan regulation compliance, the method executable by a programmed processor, the method comprising:
receiving first participant data from a first third-party data source and second participant data from a second third-party data source, wherein the first participant data comprises a plurality of first participant data entries and a plurality of first parameters, and the second participant data comprises a plurality of second participant data entries and a plurality of second parameters, wherein the plurality of first participant data entries comprise first parameter inputs that correspond to the plurality of first parameters, and wherein the plurality of second participant data entries comprise second parameter inputs that correspond to the plurality of second parameters;
retrieving, from a database associated with the processor, mapping data associated with the second third-party data source, wherein the mapping data maps the plurality of first parameters to the plurality of second parameters;
determining second participant data entries that match with first participant data entries based on the mapping data; and
comparing simultaneously the first participant data entries to matching second participant data entries to determine one or more discrepancies in participant data, wherein comparing the first participant data entries to matching second participant data entries comprises comparing first parameter inputs to second parameter inputs based on the mapping data.

2. The method of claim 1, further comprising determining a missing participant data entry when there is no second participant data entry that matches with a first participant data entry.

3. The method of claim 1, further comprising outputting a report that provides information on the one or more discrepancies.

4. The method of claim 3, wherein the report has a filter function to filter information that is relevant for employee benefit plan compliance.

5. The method of claim 3, wherein the report is output within seconds of receiving the first participant data and the second participant data.

6. The method of claim 1, wherein the mapping data maps the plurality of first parameters to locations of corresponding second parameters within a data structure of the second participant data.

7. The method of claim 6, wherein comparing first parameter inputs to second parameter inputs based on the mapping data comprises comparing first parameter inputs to corresponding second parameter inputs that are in known locations within the data structure based on the mapping data.

8. The method of claim 6, wherein the data structure is a data table and the second parameters are located within columns of the data table, and wherein the mapping data comprises an ordering of the plurality of first parameters that corresponds to an ordering of the corresponding second parameters within the columns.

9. The method of claim 8, wherein the mapping data further comprises instructions to ignore columns in the data table comprising data that is irrelevant to employee benefit plan compliance.

10. The method of claim 8, wherein the mapping data further comprises instructions to ignore columns in the data table that correspond with second parameters that have no corresponding first parameters.

11. The method of claim 1, wherein the first participant data and the second participant data comprise census data.

12. The method of claim 3, further comprising receiving, from the first third-party data source or the second third-party data source, validated participant data, wherein the validated participant data comprises matching first participant data and second participant data and corrected participant data correcting the one or more discrepancies in the participant data.

13. The method of claim 11, wherein determining second participant data entries that match with first participant data entries based on the mapping data is further based on matching social security numbers.

14. A method of generating a pre-validated employee benefit plan data reporting form, comprising:
receiving, by a processor, first census data in a first data format and second census data in a second data format, wherein the first census data comprises first employee benefit plan participant data entries and first census parameters, and wherein the second census data comprises second employee benefit plan participant entries and second census parameters, and wherein the first employee benefit plan participant data entries comprise first census parameter inputs that correspond with the first census parameters and wherein the second employee benefit plan participant entries comprise second census parameter inputs that correspond with the second census parameters;
receiving, by the processor, mapping data that identifies the second census parameters based on corresponding first census parameters;
determining, by the processor, first employee benefit plan participant data entries that match second employee benefit plan participant data entries based on the mapping data;
comparing, by the processor, first census parameter inputs to corresponding second census parameter inputs of matching first employee benefit plan participant data entries and second employee benefit plan participant data entries, wherein the corresponding second census parameter inputs correspond to the first census parameter inputs based on the mapping data;
determining, by the processor, mismatched census parameter inputs based on first census parameter inputs that differ in value from the corresponding second census parameter inputs and matching census parameter inputs based on first census parameter inputs that have a same value as the corresponding second census parameter inputs;
outputting, by the processor, discrepancy data identifying the mismatched census parameter inputs;
receiving, by the processor, validated census data comprising the matching census parameter inputs and corrected census data related to the mismatched census parameter inputs; and
populating, by the processor, fillable fields in an employee benefit plan reporting form with the validated census data.

15. The method of claim 14, wherein the employee benefit plan reporting form is a Form 5500 Series form.

16. The method of claim 14, wherein the first data format comprises first rows and first columns, and wherein the second data format comprises second rows and second columns, and wherein the first columns correspond to the first census parameters and the second columns correspond to the second census parameters, and wherein the mapping data identifies the second census parameters by mapping the first columns to the second columns based on matching first census parameters and second census parameters, and wherein the corresponding second parameter inputs correspond to the first census parameter inputs based on locations of the corresponding second parameter inputs within the second columns.

17. An employee benefit plan regulation compliance optimization system, comprising:
one or more client devices;
a processor in communication with the one or more client devices;
two or more third-party data sources in communication with the processor, wherein a first third-party data source of the two or more third-party data sources stores a first set of participant data and a second third-party data source of the two or more third-party data sources stores a second set of participant data; and
a database in communication with the processor;
wherein the processor is configured to:
receive, from the two or more third-party data sources, the first set of participant data and the second set of participant data, wherein the first set of participant data is in a system data format and the second set of participant data is in a non-system data format;
receive, from the database, mapping data that translates the non-system data format to the system data format;
compare the first set of participant data and the second set of participant data based on the mapping data;
determine one or more discrepancies between the first set of participant data and the second set of participant data based on the comparison; and
generate a report based on the one or more discrepancies.

18. The employee benefit plan regulation compliance optimization system of claim 17, wherein the database stores historical third-party data and associated mapping data, and receiving the mapping data comprises identifying historical third-party data associated with the second third-party data source and the second set of participant data.

19. The employee benefit plan regulation compliance optimization system of claim 17, wherein the system data format comprises multiple rows of first participant data of the first set of participant data and the non-system format comprises multiple rows of second participant data of the second set of participant data, and wherein comparing the first set of participant data and the second set of participant data comprises simultaneously comparing the multiple rows based on the mapping data.

20. The employee benefit plan regulation compliance optimization system of claim 17, wherein the processor is further configured to:
receive validated participant data comprising corrections to the one or more discrepancies; and
fill in an employee benefit plan reporting form with the validated participant data.
